(19) United States
(12) Patent Application Publication
(10) Pub. No.: US 2026/0115845 A1
(43) Pub. Date: Apr. 30, 2026

(54) METHOD FOR MAKING A ROTARY CUTTER

(71) Applicant: Halcyon Technology Public Company Limited, Bangkok (TH)

(72) Inventor: Pete RIMCHALA, Bangkok (TH)

(73) Assignee: Halcyon Technology Public Company Limited, Bangkok (TH)

(21) Appl. No.: 18/926,602

(22) Filed: Oct. 25, 2024

(51) Int. Cl. B23P 15/34; B23C 5/10; B23C 5/18

(52) U.S. Cl. CPC B23P 15/34; B23C 5/1081; B23C 5/18; B23C 2226/315

(57) ABSTRACT

A method of forming a rotary cutter includes forming at least one longitudinally-extending flute along a body of a rotary blank, and forming a plurality of pockets along the at least one longitudinally-extending flute. A plurality of polycrystalline diamond (PCD) segments are attached to the body, wherein each PCD segment of the plurality of PCD segments is attached to a respective pocket of the plurality of pockets. A cutting edge is formed along a leading edge of each of the PCD segments.

### FIELD OF THE INVENTION

The invention relates to rotary cutting tools and, more particularly, to a method for making rotary cutting tools.

### BACKGROUND OF THE INVENTION

Rotary cutting tools, such as fluted end mills and the like, generally are required to perform severe machining operations under extremely adverse conditions. Conventionally, cutting surfaces of one material are formed on a shaft of the tool. To enhance cutting and durability, various combinations of materials may be used, including diamond inserts or tips, which are attached to carbon steel or carbide shafts. In such combination, a diamond tip or insert must first be adhered to a carbide substrate, which is in turn soldered or brazed to the shaft. Diamond particles, being polycrystalline super-abrasive materials, are typically formed into a compact or polycrystalline diamond (PCD) disc. Though PCD and polycrystalline cubic born nitride (PCBN) have been used in both metalworking and woodworking industries due to their high abrasive resistance, high toughness, and high hardness, these super-abrasive materials tend to be costly when compared to other options. Generally, helical shapes are not readily fabricated from PCD or PCBN under High Pressure High Temperature (HPHT) sintering process due to complexity in design in combination with their super-hard physical characteristics. Further, any conventional shaping process that attempts to put the flute or helical shape into a super-abrasive material by finishing operations (e.g., grinding) is a difficult and costly process.

U.S. Pat. No. 5,070,748 discloses a cylindrical tungsten carbide rod with polycrystalline diamond (PCD) veins sintered into the periphery, where diamond powder material is compacted within grooves of the tungsten carbide rod (or other material) and sintered in a press. The rod is machined to create the desired cutting edge geometries along the PCD veins. Due to the high cost of the material and the limited availability of product variation, such rods with PCD veins are only feasible to a small market.

Therefore, there is a need for a method of making a helical or fluted PCD drill tip and a PCD fluted end mill that are cost competitive and reliable in tool performance over the existing super-abrasive tools.

### SUMMARY OF THE INVENTION

A method of forming a rotary cutter in accordance with the invention provides a cutter with polycrystalline materials, where a plurality of polycrystalline segments are attached to respective pockets formed along a longitudinally-extending flute of the rotary cutter, where the polycrystalline segments have different shapes and lengths per flute. More particularly, a plurality of individual PCD segments can be mounted in respective pockets formed in the flutes. The segments can be arranged in a continuous manner to form a helical array, the axis of the helix being concentric with the axis of the rotary cutter. Each segment on one flute is slightly offset with respect to another corresponding segment in any adjacent flute to form a vertical array. Thus, each flute has multiple segment pieces. The PCD segments then are machined to form a cutting edge.

Advantageously, the inventive method enables the formation of a helical PCD/PCBN tool with flexibility on the end geometry for cutters with PCD as the cutting edge. Additionally, the inventive method enables manufacture of ball-nose end mills and end mills with large corner radii. Further, a rotary cutter formed from the method in accordance with the invention in which segments are placed adjacent to one another along a helix produces no gap between adjacent PCD segments.

According to one aspect of the invention, a method of forming a rotary cutter includes: obtaining a rotary blank having a first end, a second end opposite the first end, and a body disposed between the first end and the second end; forming at least one longitudinally-extending flute along the body; forming a plurality of pockets along the at least one longitudinally-extending flute; attaching a plurality of polycrystalline diamond (PCD) segments to the body, wherein each PCD segment of the plurality of PCD segments is attached to a respective pocket of the plurality of pockets; and forming a cutting edge along a leading edge of each of the PCD segments.

In one embodiment, forming at least one longitudinally-extending flute includes forming a first longitudinally-extending flute and a second longitudinally-extending flute, and wherein attaching the plurality of PCD segments includes attaching a first group of PCD segments to pockets formed along the first longitudinally-extending flute and attaching a second group of PCD segments to pockets formed along the second longitudinally-extending flute such that an interface between two adjacent PCD segments of the first group of PCD segments is axially offset along the body relative to an interface between two adjacent PCD segments of the second group of PCD segments.

In one embodiment, forming the at least one longitudinally-extending flute comprises grinding the rotary blank to form the at least one longitudinally-extending flute.

In one embodiment, forming the at least one longitudinally-extending flute includes forming at least one longitudinally-extending helical flute along the body.

In one embodiment, forming the plurality of pockets includes forming the plurality of pockets along a periphery of the at least one longitudinally-extending flute.

In one embodiment, forming the plurality of pockets includes forming a first pocket in a first region along the periphery of the at least one longitudinally-extending flute, and forming a second pocket in a second region along the periphery of the at least one longitudinally-extending flute, the second pocket immediately-adjacent to and nonparallel to the first pocket.

In one embodiment, forming the plurality of pockets includes forming the plurality of pockets to have a rectangular or trapezoidal cross-section.

In one embodiment, forming the plurality of pockets includes grinding a surface of the body along an outer edge of the at least one longitudinally-extending flute to form the plurality of pockets.

In one embodiment, forming the plurality of pockets includes forming a first pocket of the plurality of pockets along an outer edge of the at least one longitudinally-extending flute and forming a second pocket of the plurality of pockets along an outer edge of the same at least one longitudinally-extending flute, the second pocket immediately adjacent to the first pocket, wherein a longitudinal axis of the second pocket is nonparallel to a longitudinal axis of the first pocket.

In one embodiment, forming the plurality of pockets includes forming a first pocket of the plurality of pockets along an outer edge of the at least one longitudinally-extending flute and forming a second pocket of the plurality of pockets along an outer edge of the same at least one longitudinally-extending flute, the second pocket immediately adjacent to the first pocket, wherein the first pocket and the second pocket are at least partially misaligned with respect to a helical path of the outer edge of the at least one longitudinally-extending helical flute.

In one embodiment, the method includes prior to attaching the plurality of PCD segments, cutting the plurality of PCD segments from at least one PCD disk.

In one embodiment, cutting includes cutting the plurality of PCD segments into a rectangular or trapezoidal shape.

In one embodiment, cutting includes cutting ends of each PCD segment of the plurality of PCD segments at an angle such that when two PCD segments are attached to adjacent non-parallel pockets on the body the angle of the adjacent ends of the PCD segments correspond to one another.

In one embodiment, cutting includes cutting ends of each PCD segment of the plurality of PCD segments at an angle such that when two PCD segments are attached to adjacent non-parallel pockets on the body each PCD segment joins the adjacent PCD segment along the helical flute.

In one embodiment, attaching the plurality of PCD segments includes brazing each PCD segment of the plurality of PCD segments to a respective pocket of the plurality of pockets.

In one embodiment, obtaining the rotary blank includes obtaining a rotary blank formed from at least one of tungsten carbide, steel or ceramic.

In one embodiment, forming the cutting edge includes machining the plurality of PCD segments.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The invention may take physical form in certain parts and arrangement of parts, an embodiment of which is described in detail in the specification and illustrated in the accompanying drawings.

FIG. 1A is a side view of an exemplary rotary cutting tool formed according the method in accordance with the invention.

FIG. 1B is an end view of the rotary cutting tool of FIG. 1A.

FIG. 1C is a partial side view of the rotary cutting tool of FIG. 1A.

FIG. 2 is a side view of an exemplary rotary cutting tool showing pockets formed therein in accordance with the present invention.

FIG. 3A is a side view of an exemplary rotary cutting tool showing PCD segments attached to the pockets in accordance with the present invention.

FIG. 3B illustrates PCD disks, from which PCD segments for use in forming a cutting tool in accordance with the invention.

FIG. 4 is a schematic diagram illustrating the arrangement and shape of PCD segments for a rotary cutting tool formed in accordance with the invention.

FIG. 5 is a side view of the rotary cutting tool of FIG. 3A after machining to form the cutting surface.

FIG. 6 is a flow chart illustrating exemplary steps of a method for forming a rotary cutting tool in accordance with the invention.

### DETAILED DESCRIPTION OF THE INVENTION

Embodiments of the present invention will now be described with reference to the drawings, wherein like reference numerals are used to refer to like elements throughout. It will be understood that the figures are not necessarily to scale.

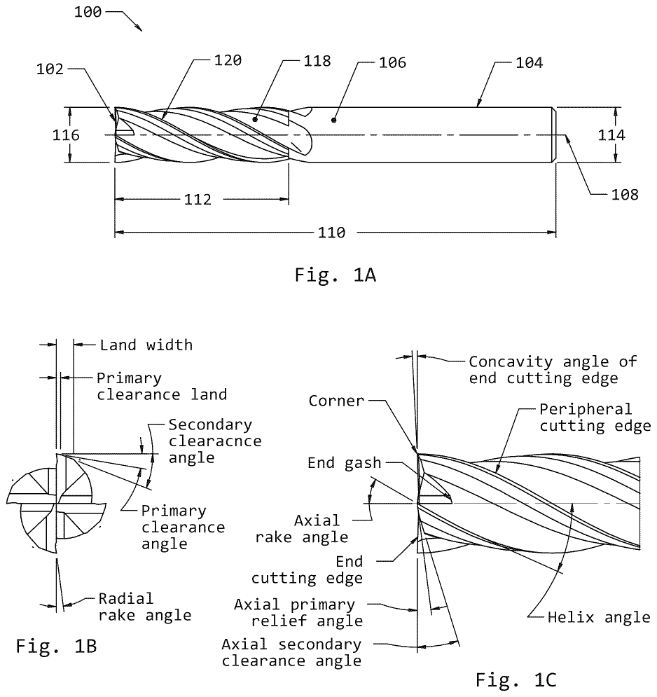

Referring to FIGS. 1A-1C, illustrated are side, end and partial side views of an exemplary rotary cutting tool 100 having generally cylindrical shape, where FIGS. 1B and 1C further describe the angles for various features formed in the rotary cutting tool 100. The rotary cutting tool 100 includes a cutting end 102, a base end 104 distal from the cutting end 102, and a body 106, each disposed symmetrically about a longitudinal axis 108 of the rotary cutting tool 100. The body 106 is disposed between and connects the cutting end 102 and the base end 104.

The rotary cutting tool 100 has a length 110, and the cutting end 102 has a length 112. In the illustrated embodiment a base end diameter 114 is greater than a cutting end diameter 116, although the base end diameter 114 may be smaller than the cutting end diameter 116 depending on the specific application for the tool. At least one flute 118 is formed on a sidewall of the body 106 and extends from the cutting end 102 toward base end 104. A cutting surface 120 is formed adjacent to an edge of each flute 118 and spirally extends along the sidewall of the flute 118. As will be described in further detail below, the cutting edge 120 is formed by creating a plurality of pockets in an edge of the flute 118, and then attaching polycrystalline segments having different angles and lengths per flute 118 to respective ones of the plurality of pockets. The polycrystalline segments are then machined to produce the cutting surface 120.

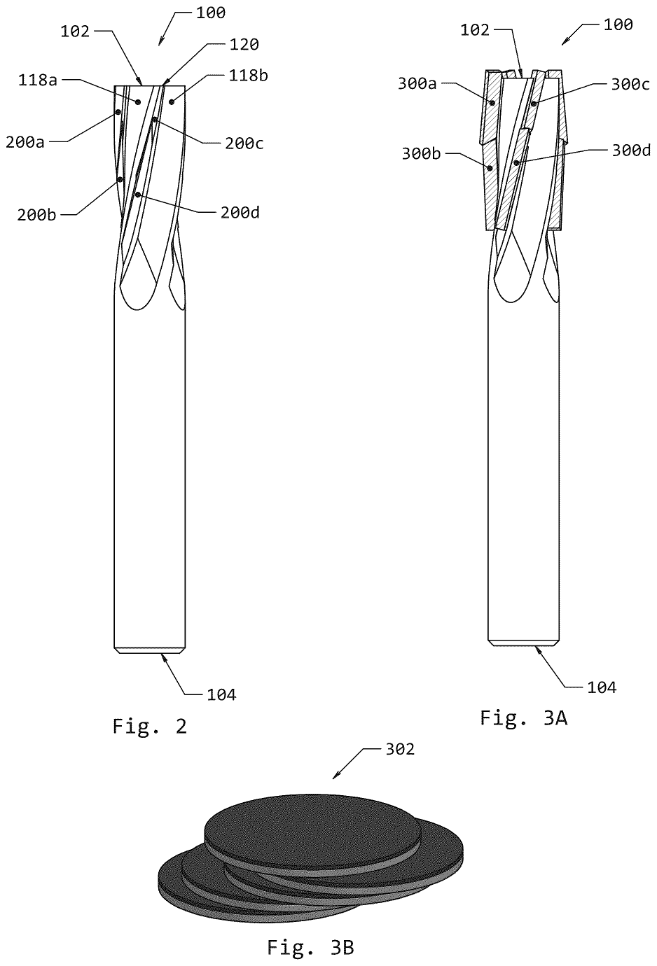

With additional reference to FIGS. 2, 3A and 3B, and as noted above, the cutting surface 120 along the edge of each flute 118a, 118b is formed from a plurality of individual pockets 200a, 200b, 200c, 200d (generally referred to as pockets 200) each having a longitudinal axis. Each pocket 200a-200d may have a rectangular or trapezoidal shape, and the longitudinal axes of adjacent pockets are non-parallel to each other. PCD segments 300a, 300b, 300c, 300d (generally referred to as PCD segments 300) obtained from a PCD disk 302 are inserted into respective pockets 200a-200d and secured, for example, by brazing or soldering, where ends of adjacent segments, e.g., 300a and 300b; 300c and 300d, are configured to minimize any gap between the respective adjacent segments.

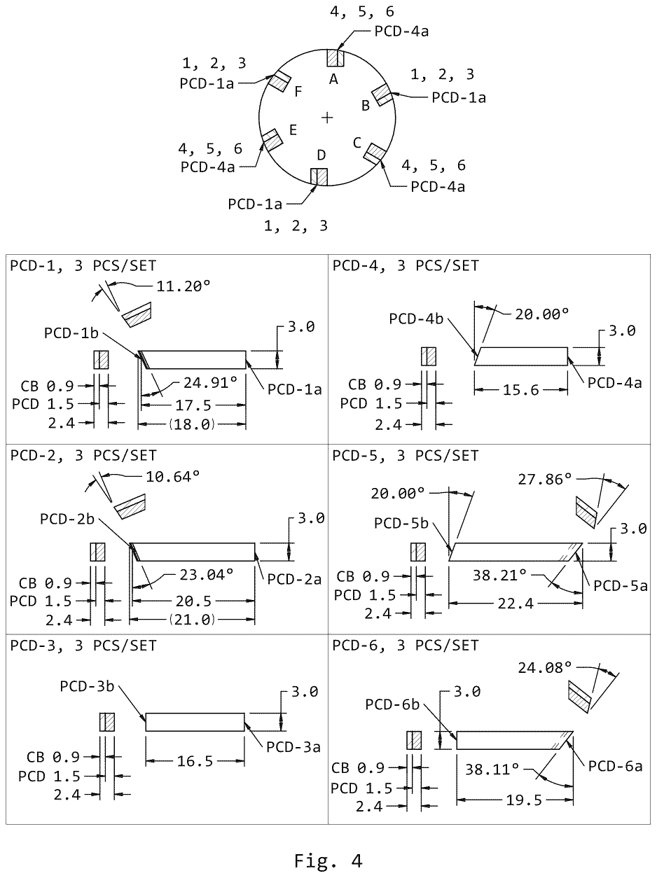

For example, and with reference to FIG. 4, an end view of a rotary cutting tool 100 is illustrated, the tool 100 having six flutes labeled A, B, C, D, E and F, each flute having pockets 200 formed therein and PCD segments 300 attached to respective pockets 200. The segments are generally trapezoidal or rectangular in shape, with four sidewalls and two opposing faces, although other shapes may be utilized depending on the pocket configuration.

FIG. 4 also shows the configuration of six different PCD segments, labeled PCD-1, PCD-2, PCD-3, PCD-4, PCD-5 and PCD-6. As can be seen in FIG. 4, each PCD segment 300 is configured slightly different from one another. Segments PCD-1, PCD-2 and PCD-3 form a first group of segments, while segments PCD-4, PCD-5 and PCD-6 form a second group of segments. The first and second groups of segments are arranged in an alternating order around the tool body. For example, segments PCD-4, PCD-5 and PCD-6 are placed in each of flutes A, C and E, while segments PCD-1, PCD-2, PCD-3 are placed in each of flutes B, D and F.

As noted above, the first group of segments includes a first segment PCD-1, second segment PCD-2, and third segment PCD-3. The first segment PCD-1 is generally trapezoidal having a top face PCD-1a that is generally perpendicular to one or more sidewalls of the segment PCD-1. The top face PCD-1a forms the tip (end) of the cutting tool 100 and can be seen in the top view of FIG. 4. The first segment PCD-1 also includes a bottom face PCD-1b that is multi-angled with a first face angled at 11.2 degrees relative to one or more sidewalls of the segment and a second face angled at 24.91 degrees relative to one or more sidewalls of the segment. The second segment PCD-2 is also generally trapezoidal in shape and has a top face PCD-2a that is generally perpendicular to one or more sidewalls of the segment, and a bottom face PCD-2b having a first face angled at 10.64 degrees and a second face angled at 23.04 degrees relative to one or more sidewalls of the segment. Segment PCD-2 is placed on the tool body such that the top face PCD-2a of the second segment PCD-2 is immediately adjacent to the bottom face PCD-1b of the first segment PCD-1. The third segment PCD-3 is rectangular in shape and has a top face PCD-3a and a bottom face PCD-3b, each of which is generally perpendicular to one or more sidewalls of the segment. Segment PCD-3 is placed on the tool body such that the top face PCD-3a of the third segment PCD-3 is immediately adjacent to the bottom face PCD-2b of the second segment PCD-2. The segments PCD-1, PCD-2 and PCD-3 are machined into a cutting surface, as described in further detail below.

The second group of segments includes a fourth segment PCD-4, fifth segment PCD-5, and sixth segment PCD-6. The fourth segment PCD-4 is trapezoidal having a top face PCD-4a that is generally perpendicular to one or more sidewalls of the segment PCD-4. The top face PCD-4a forms the tip (end) of the cutting tool 100 and can be seen in the top view of FIG. 4. The fourth segment PCD-4 also includes a bottom face PCD-4b that has a face angled at 20 degrees relative to one or more sidewalls of the segment. The fifth segment PCD-5 is also trapezoidal in shape and has a top face PCD-5a that has a first portion that is angled at 27.86 degrees with respect to one or more sidewalls of the segment and a second portion that is angled at 38.21 degrees with respect to one or more sidewalls of the segment, and a bottom face PCD-5b having a face angled at 20 degrees relative to one or more sidewalls of the segment. Segment PCD-5 is placed on the tool body such that the top face PCD-5a of the fifth segment PCD-5 is immediately adjacent to the bottom face PCD-4b of the fourth segment PCD-4. The sixth segment PCD-6 is also trapezoidal in shape and has a top face PCD-6a and a bottom face PCD-6b. The top face PCD-6a is angled at 24.08 degrees with respect to one or more sidewalls of the segment, while the bottom face PCD-6b is generally perpendicular to one or more sidewalls of the segment. Segment PCD-6 is placed on the tool body such that the top face PCD-6a of the sixth segment PCD-6 is immediately adjacent to the bottom face PCD-5b of the fifth segment PCD-5. The segments PCD-4, PCD-5 and PCD-6 are machined into a cutting surface, as described in further detail below.

It is noted that the above angular relationships, the dimensions shown in the figures and the number of segments per flute are merely exemplary, and other angles, dimensions and number of segments may be utilized depending on the characteristics of the cutting tool.

The arrangement of segments not only produces a minimal gap between adjacent PCD segments of a respective flute, but also shifts the location at which two segments contact each other relative to where two segments contact each other on adjacent flutes, i.e., the interface between adjacent segments of one flute are axially offset relative to the interface between adjacent segments of another flute. By minimizing or eliminating the gap between adjacent segments of a flute, the cutting efficiency of the resulting rotary cutter is improved. Further, by axially shifting a location of the interface between adjacent segments of a flute relative to other flutes, a clean cut can be achieved.

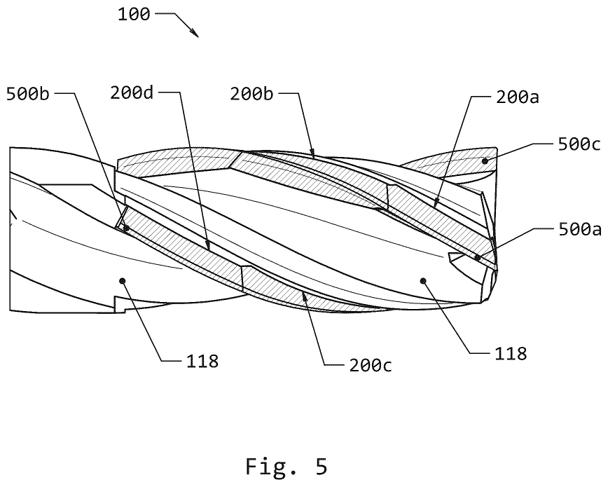

Once the PCD segments 300 are attached and secured to the respective pockets 200, they are machined using conventional techniques to produce a substantially continuous cutting surface, FIG. 5 illustrates the rotary cutting tool 100 after machining, showing the machined PCD segments 300 forming substantially continuous cutting surfaces 500a, 500b, 500c along outer regions of the flutes 118. As used herein, a “substantially continuous cutting surface” is defined as a cutting surface that does not have any gaps between adjacent segments that exceed 0.2 mm.

In conventional PCD end mills, the flank face is machined while the flute face (also referred to as the rake face) is un-machined and therefore are flat. Further, the PCD segments of conventional end mills are on the same plane. In contrast, PCD pieces for a rotary cutting tool formed according to the invention have the flute (rake) face machined to create a 3-dimensional geometry, thereby providing a desired radial rake angle and spiral angle. As a result of an optimal radial rake angle and spiral angle, the rotary cutter can cut materials with less force from its shearing effect thereby reducing heat occurred.

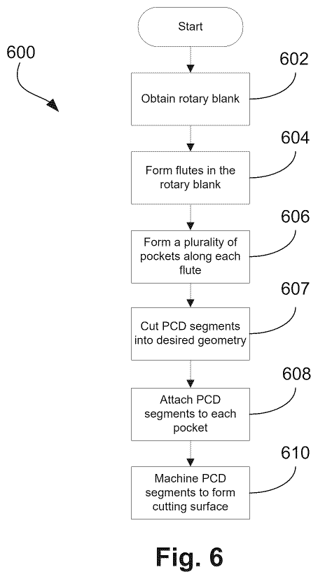

Referring now to FIG. 6, illustrated is a flow chart 600 that provides exemplary steps for making a rotary cutter in accordance with the invention. The flow chart 600 includes a number of process blocks arranged in a particular order. As should be appreciated, many alternatives and equivalents to the illustrated steps may exist and such alternatives and equivalents are intended to fall with the scope of the claims appended hereto. Alternatives may involve carrying out additional steps or actions not specifically recited and/or shown, carrying out steps or actions in a different order from that recited and/or shown, and/or omitting recited and/or shown steps. Alternatives also include carrying out steps or actions concurrently or with partial concurrence.

Beginning at step 602, a rotary blank is obtained, the rotary blank having a cylindrical shape. While a cylindrical shape is preferred, it will be appreciated that other shapes are possible. For example, rectangular or other angular shapes could be utilized. However, such alternative shapes may require additional machining and/or processing steps. The rotary blank, which may be formed from one or more of tungsten carbide, steel or ceramic materials, has a first end, a second end opposite (distal) the first end, and a body disposed between and connecting to the first end and the second end.

Next at step 604, at least one and preferably two or more longitudinally-extending flutes 118 are formed from the first end and into at least part of the body 106 of the rotary blank. The one or more flutes 118, which may be helically-shaped, can be formed, for example, by grinding a helical channel in the rotary blank as is conventional. At step 606, for each of the flutes 118 a plurality of individual pockets 200 are formed in and/or along an outer edge of the flutes 118. In this regard, each pocket 200 may be formed by grinding the flute 118 and/or along an outer edge of each flute 118 to form a channel that is open along a top surface of the flute 118. For example, for a first flute 118a a first pocket 200a may be formed in a first region along a periphery of the respective flute 118a, and then a second pocket 200b may be formed in a second region along the periphery of the first flute 118a immediately adjacent to the first pocket 200a, and so on. This process is repeated for each additional flute 118 (e.g., flute 118b includes a first pocket 200c formed in a first region along the periphery of the flute and a second pocket 200d formed in a second region along the periphery of the flute) such that each flute has a plurality of pockets that extend along at least part and preferably the entire length of the flute. Each pocket 200a-200d is formed as a channel that is open on a top region, each pocket 200a-200d having a longitudinal axis, where the longitudinal axis of each pocket is non-parallel to a longitudinal axis of an immediately adjacent pocket along the respective flute, e.g., the immediately-adjacent pockets are at least partially misaligned with respect to one another and/or with respect to a helical path of the outer edge of the respective flute 118. In some embodiments, the pockets 200a-200d are formed to have a rectangular and/or trapezoidal cross section. Preferably, a pocket on one flute segment is axially offset with respect to a corresponding pocket on radially adjacent flute segment, such that the ends of a pocket on one flute are offset from the ends of a pocket on an adjacent flute. Preferably, the axial offset is in the range of 0.3-1.0 mm. However, in another embodiment the pockets can be formed such that the ends of the pockets 118a and 118b are not axially offset (i.e., the pockets of one flute start/end on the same axial location as the respective pockets of another flute).

Next at step 607 the PCD segments 302 are cut into the desired geometry. For example, and with respect to the embodiment in which the pockets are axially offset between flutes, the segments can be cut to have a length and width that corresponds to the pocket in which the segment is to be inserted. In the embodiment in which the pockets are not axially offset between adjacent flutes, the end faces of each segment are cut such that when placed in pockets of one flute a location of the interface between two PCD segments of the one flute is axially offset relative to the interface between respective PCD segments of another flute.

Moving to step 608, PCD segments 300 are attached to the body and specifically PCD segments 300a-300d are attached to respective ones of the plurality of pockets 200a-200d formed in the flutes 118, for example, by brazing or soldering each PCD segment 300a-300d to a respective pocket 200a-200d. The PCD segments 300a-300d can be arranged continuously, one after another, along the edge of the flute, in the pockets 200, i.e., each segment is positioned in a pocket 200 along a flute 118 in a continuous manner, thereby forming a horizontal array. Such arrangement can avoid the limitation found in the prior art in which a single piece of flat (two-dimensional) PCD segment cannot be brazed onto the carbide shank due to the flute's twisted and helical geometry.

Additionally, in the embodiment where each pocket 200 on one flute 118 is intentionally misaligned with a corresponding pocket 200 in any adjacent flutes, the PCD segments 300 inserted in these pockets 200 will inherently also be misaligned with respect to each other such that an interface between two adjacent PCD segments (e.g., the interface between segments 300a, 300b) of a first flute 118a is axially offset along the body relative to an interface between two adjacent PCD segments (e.g., the interface between segments 300c, 300d) of the second group of PCD segments of a second flute 118b. Put another way, a first segment edge and a second segment edge immediately adjacent to the first segment edge are arranged in a manner that the adjacent segment edges of one flute 118a do not exactly align with segment edges of other adjacent flutes 118b in the vertical array. Instead, each interface on one flute is offset with respect to adjacent interface in any adjacent flute, where such offset produces a displacement on the order of 0.3-1.0 mm. As a result, the segment edge of a pair of adjacent PCD segments in one flute do not exactly align with the segment edge of a pair of adjacent PCD segments of other adjacent flutes in the vertical array. In the embodiment in which each pocket on the flute 118 is aligned, then the angle(s) of the PCD segments cause the interface (gap) to be at a different axial location on the cutting edge.

For example, segment 300a and segment 300b are attached to pockets 200a, 200b, respectively, to form a first horizontal array of segments (a first group of segments) along a first longitudinally-extending flute 118a, and segments 300c and 300d are attached to pockets 200c, 200d, respectively, to form a second horizontal array of segments (a second group of segments) along a second longitudinally-extending flute 118b that is radially shifted on the body relative to the first vertical array. In this regard, two horizontal arrays may be said to form a vertical array of PCD segments. The interface between segment 300a and segment 300b of the first horizontal array and the interface between segment 300c and 300d of the second horizontal array correspond to each other as they are immediately adjacent to each other in the radial direction. Due to the axial offset in the respective pockets 200a, 200c (or the different angles between faces of adjacent PCD segments), the interface between PCD segments 300a and 300b and the interface between PCD segments 300c and 300d will also have a corresponding axial offset relative to each other (e.g., 0.3-1 mm offset).

In attaching the PCD segments 300a-300d, pre-cut PCD segments may be obtained, or alternatively the PCD segments may be cut from the PCD disk prior to attachment. The PCD segments may be cut, for example, from a PCD disk. The PCD segments 300a-300d may be rectangular or trapezoidal shape, or any other shape so long as the shape corresponds to the shape of the pockets 200a-200d. In cutting or forming the PCD segments 300a-300d, ends of some of the PCD segment may be cut at an angle such that when two PCD segments are attached to adjacent non-parallel pockets on the body the angle of the adjacent ends of the PCD segments provide a smooth transition between the segments so as to reduce or eliminate any gap between the two PCD segments, e.g., adjacent segments are cut such that at the interface between adjacent segments each PCD segment joins the adjacent PCD segment along the helical flute. A width of each segment is preferably configured in the range of 1.5-5 mm, more preferably between 2-3 mm, and a length of each segment is preferably configured in the range of 3.2-18 mm. The length of each PCD segment 300a-300d can vary based on a cutting diameter, cutting length and helix angle of the cutting end 102. For example, the length can be in the range of 3.2-10.8 mm when the cutting diameter is in the range of 8-10 mm, the cutting length is in the range of 0-40 mm, and the helix angle is in the range of 5-60 degrees. The length can also be in the range of 4-10.8 mm when the cutting diameter is in the range of 10-16 mm, the cutting length is in the range of 0-64 mm, and the helix angle is in the range of 5-60 degrees. The length can also be in the range of 4.8-10.8 mm when the cutting diameter is in the range of 16-18 mm, the cutting length is in the range of 0-72 mm, and the helix angle is in the range of 5-60 degrees. The length can also be in the range of 6.4-12 mm when the cutting diameter is in the range of 18-22 mm, the cutting length is in the range of 0-88 mm, and the helix angle is in the range of 5-60 degrees. The length can also be in the range of 6.4-14.4 mm when the cutting diameter is in the range of 22-25 mm, the cutting length is in the range of 0-100 mm, and the helix angle is in the range of 5-60 degrees. The length can also be in the range of 7.2-18 mm when the cutting diameter is in the range of 25-32 mm, the cutting length is in the range of 0-128 mm, and the helix angle is in the range of 5-60 degrees.

Next at step 610 a cutting surface is formed along a leading edge of each of the PCD segments. The cutting surface may be formed by machining the PCD segments 300a-300d.

In the illustrated embodiment the finished rotary cutting tool 100 has a body in the shape of a round shaft having a uniform diameter. In some embodiments, the body of the rotary cutter can have varying widths, depending on the size of the intended tool holder, or preferences of the user. Further, an end of the rotary cutting tool 100 can be shaped or formed to fit with several tool holders, depending on the user's preferences. FIG. 1 shows the end as a round, flat end, but other end shapes could include, but are not limited to, square, oval, spindle, or other angular shapes.

Modifications and alterations of the structures shown in the drawings will become apparent to those skilled in the art after reading the present specification. It is intended that all such modifications and all variations being included in so far as they come within the scope of the patent as claimed or the equivalence thereof.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

1. A method of forming a rotary cutter, comprising:
obtaining a rotary blank having a first end, a second end opposite the first end, and a body disposed between the first end and the second end;
forming at least one longitudinally-extending flute along the body;
forming a plurality of pockets along the at least one longitudinally-extending flute;
attaching a plurality of polycrystalline diamond (PCD) segments to the body, wherein each PCD segment of the plurality of PCD segments is attached to a respective pocket of the plurality of pockets; and
forming a cutting edge along a leading edge of each of the PCD segments.

2. The method according to claim 1,
wherein forming at least one longitudinally-extending flute comprises forming a first longitudinally-extending flute and a second longitudinally-extending flute, and
wherein attaching the plurality of PCD segments comprises attaching a first group of PCD segments to pockets formed along the first longitudinally-extending flute and attaching a second group of PCD segments to pockets formed along the second longitudinally-extending flute such that an interface between two adjacent PCD segments of the first group of PCD segments is axially offset along the body relative to an interface between two adjacent PCD segments of the second group of PCD segments.

3. The method according to claim 1, wherein forming the at least one longitudinally-extending flute comprises grinding the rotary blank to form the at least one longitudinally-extending flute.

4. The method according to claim 1, wherein forming the at least one longitudinally-extending flute comprises forming at least one longitudinally-extending helical flute along the body.

5. The method according to claim 1, wherein forming the plurality of pockets comprises forming the plurality of pockets along a periphery of the at least one longitudinally-extending flute.

6. The method according to claim 1, wherein forming the plurality of pockets comprises forming a first pocket in a first region along the periphery of the at least one longitudinally-extending flute, and forming a second pocket in a second region along the periphery of the at least one longitudinally-extending flute, the second pocket immediately-adjacent to and nonparallel to the first pocket.

7. The method according to claim 1, wherein forming the plurality of pockets comprises forming the plurality of pockets to have a rectangular or trapezoidal cross-section.

8. The method according to claim 1, wherein forming the plurality of pockets comprises grinding a surface of the body along an outer edge of the at least one longitudinally-extending flute to form the plurality of pockets.

9. The method according to claim 1, wherein forming the plurality of pockets comprises forming a first pocket of the plurality of pockets along an outer edge of the at least one longitudinally-extending flute and forming a second pocket of the plurality of pockets along an outer edge of the same at least one longitudinally-extending flute, the second pocket immediately adjacent to the first pocket, wherein a longitudinal axis of the second pocket is nonparallel to a longitudinal axis of the first pocket.

10. The method according to claim 1, wherein forming the plurality of pockets comprises forming a first pocket of the plurality of pockets along an outer edge of the at least one longitudinally-extending flute and forming a second pocket of the plurality of pockets along an outer edge of the same at least one longitudinally-extending flute, the second pocket immediately adjacent to the first pocket, wherein the first pocket and the second pocket are at least partially misaligned with respect to a helical path of the outer edge of the at least one longitudinally-extending helical flute.

11. The method according to claim 1, further comprising prior to attaching the plurality of PCD segments, cutting the plurality of PCD segments from at least one PCD disk.

12. The method according to claim 11, wherein cutting comprises cutting the plurality of PCD segments into a rectangular or trapezoidal shape.

13. The method according to claim 11, wherein cutting includes cutting ends of each PCD segment of the plurality of PCD segments at an angle such that when two PCD segments are attached to adjacent non-parallel pockets on the body the angle of the adjacent ends of the PCD segments correspond to one another.

14. The method according to claim 8, wherein cutting includes cutting ends of each PCD segment of the plurality of PCD segments at an angle such that when two PCD segments are attached to adjacent non-parallel pockets on the body each PCD segment joins the adjacent PCD segment along the helical flute.

15. The method according to claim 1, wherein attaching the plurality of PCD segments comprises brazing each PCD segment of the plurality of PCD segments to a respective pocket of the plurality of pockets.

16. The method according to claim 1, wherein obtaining the rotary blank comprises obtaining a rotary blank formed from at least one of tungsten carbide, steel or ceramic.

17. The method according to claim 1, wherein forming the cutting edge comprises machining the plurality of PCD segments.

18. A rotary cutter formed by the method according to claim 1.
